(19) United States
(12) Patent Application Publication
(10) Pub. No.: US 2005/0253473 A1
(43) Pub. Date: Nov. 17, 2005

(54) Alternative magnetic bearing

(76) Inventor: Philip A. Studer, Silver Spring, MD (US)

Correspondence Address: PHILIP A. STUDER, APT. 209, 3126 GRACEFIELD RD., SILVER SPRING, MD, 20904, US

(21) Appl. No.: 10/844,000

(22) Filed: May 13, 2004

(51) Int. Cl. H02K 7/09

(52) U.S. Cl. 310/90.5

(57) ABSTRACT

This disclosure describes a new means for suspending and/or centering bodies without physical contact while avoiding some of the characteristic destabilizing forces between ferrous surfaces of prior magnetic bearings. It allows more linear control and produces bidirectional forces while retaining the wearout free and environmental and speed independence obtainable only by magnetic suspension. Single degree of freedom bearings are shown first. Axial, then two types of radial (2 axis) implementations, then four and five axis systems which can be motorized. Finally a “best mode” in which all six degrees of freedom are combined illustrating a uniquely practical configuration is shown. In all cases displacement sensors and conventional electronic control systems are needed and their use is implied since their availability unquestioned as are power supplies.

### BACKGROUND OF THE INVENTION

This invention relates to the need to maintain the position of the rotor centered in the assembly with the least retardation of its rotational motion. This function is usually performed by bushings, ball, or fluid film bearings. These are prone to wear out and in certain environments for instance the vacuum of outer space they are inherently unsuitable or illperforming. For these reasons and to achieve the ultimate in reliability and near zero drag or rotational loss, magnetic bearings have been developed. Prior versions of magnetic bearings as designed by myself and many others both here and abroad, varied the magnetic flux in the gap between the stator and rotor, this required considerable power and robust control to overcome the large forces between close fitting ferrous parts.

### PRIOR ART

The first magnetic bearings to my knowledge were developed by Joseph Lyman of Cambridge Thermionic Corp. subsequently awarded a contract by NASA (GSFC). These were axially active, electronically controlled, and radially and torsionally passive. The device consisted of concentric cylinders with the control coil between the inner and the outer cylinder. On one end of each cylinder were salient poles to increase the radial stiffness facing matching poles on flanges projecting from the inner cylinder to the outer diameter on one end and from the c Vcuter cylinder to the rotor, facing mating stationary pole faces. Application of power caused currents to flow in both coils, sufficient to generate sufficient flux to provide radial support were differentially controlled to equalize the gaps at either end allowing free rotation.

These first magnetic bearings contained no permanent magnets, all of the flux being generated by the control currents. Permanent magnets were introduced at Goddard Space Flight Center in such a way that the permanent magnet circuit reluctance did not change drastically with gap displacement (there being a corresponding increase on one side with a decrease on the other) while control flux circuit operated on gaps on both, increasing or decreasing. The control currents merely modulated rather than supplied the total flux saving power.

A second step forward was the pancake geometry, using a single disk permanent magnet with permeable end plates through which control fluxes could be directed across the diameter through circumferential airgaps to a ring extending from the upper to the lower plates. This device easily produced radial forces and the large diameter to height ratio allowed it to be passively stable both axially and in torsion. This device was installed in a reaction wheel with a large diameter “ironless” armature motor which was widely displayed at various technical meetings in operation.

### SUMMARY

The basic concept upon which this invention is based is the principle of F=BI. This contrasts with prior magnetic bearings which were based on F=KBB, while the latter is effective, it contains many inherent difficulties.

The use of a fixed magnetic structure allows all of the large attractive forces between parts of the magnetic circuit to be opposed structurally so they have no effect on the bodies motion. It will be noted that these large forces, although minimized by balanced design, are imposed on the bearing systems of conventional design, where they lead to start up wear and problems in fluid film bearings and eventual failure of lubricated ball and bushing type arrangements. Permanent magnets, while not essential, offer economical, compact, and power saving source of magnetic flux.

The advantages of non-contacting bearings are many relating to the elimination of wear-out phenomena but especially in environmentally sensitive areas, such as fuel tank pumps, fuel cells, and clean room blowers.

The making and using of bearings of this type is more feasible and readily implemented since the construction and materials are in common use in specialized motors in mass production and, recent progress in sensors and electronic control have led to miniaturization and greater efficiency in there common use.

There bearings solve some of the problems characteristic of earlier practice:
1. Reluctance changes in the magnetic circuit being controlled.
2. Inductance of the circuits being controlled.
3. The nonlinearity inherent in F=KBB techniques.
4. The unidirectionality of attractive magnetics.
   Alternate Magnetic Bearing

The following is a description of a recent invention by the writer which has significant advantages over previous methods of my own and as far as my search informs me any other.

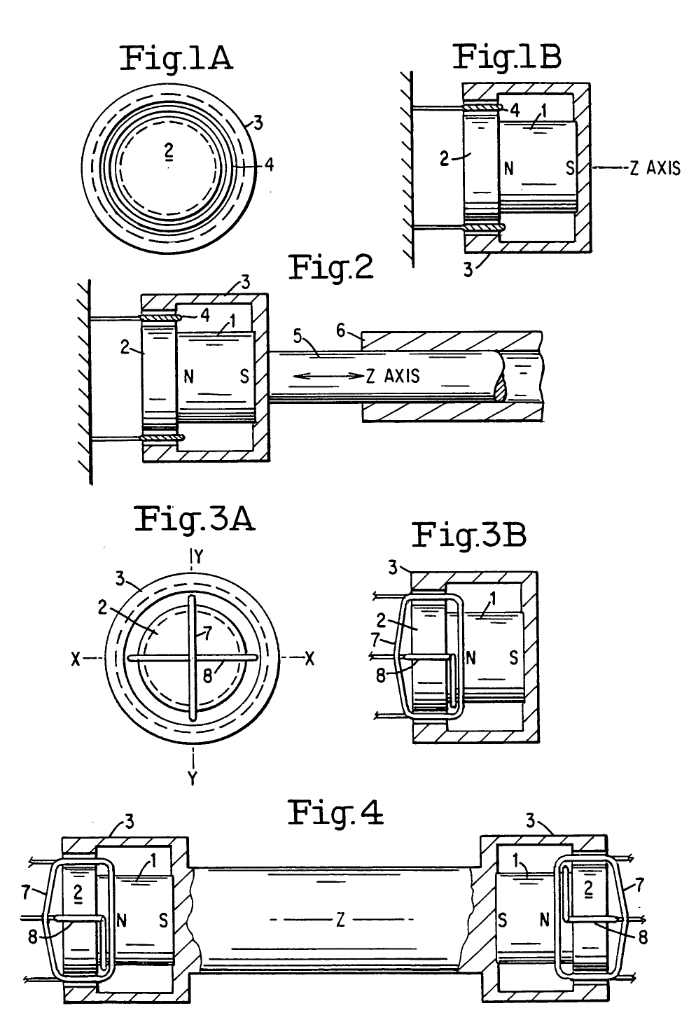

FIG. 1 shows a cup shaped piece of high permeability material into which is a disk permanent magnet surmounted by a slightly larger high permeability disk, leaving open a circular slot through which a high density magnetic flux flows radially. Into this slot a coil of wire can be situated where the current flowing through the coil is entirely intersected by the flux. It will be seen that this is identical action to a loudspeaker coil and that a force is generated between the coil and the magnet structure. The difference is that this current is made to be proportional to a position sensor signal, amplified by a power amp., and producing a force between a stationary coil and the moveable magnet structure, perpendicular to both the flux path and the current path. The use of this device differs as shown in FIG. 2, where the coil is fixed and the magnet assembly controlled to resist external disturbing influences.

There is no physical or electrical contact or connection required. Since the first figure shows only single degree of freedom control essentials, the need for radial and torsional suspension and control could be supplied mechanically by means of a shaft and surrounding bushing allowing free axial motion.

The ability of this invention to provide radial support can be shown by an identical magnet assembly equipped with a pair of coils, each with axially directed conductors passing through the high magnetic flux density region in its circular slot, with inwardly directed current at one location and its return as outwardly directed current 180 degrees displaced. See FIG. 3. Since these currents are axial and the magnetic flux radial, therefore the force generated by their interaction will be perpendicular to both of them. It will be tangential to the airgap, equal in magnitude, and in the same direction although 180 degrees apart; thus together, they add to produce lateral force. Another similar coil perpendicular to the first set of conductors would provide means for radially directed force in a perpendicular direction. If each is controlled in magnitude and current direction, they can produce controllable forces over the entire plane.

The current control is readily supplied and regulated in accordance with radial position sensors in each axis and available electronic power amplification. Compensation and known servo system techniques can be applied to achieve and maintain radial position suspension and stability.

It is evident that with sufficiently strong permanent magnets, the circular slot, which represents most of the reluctance, in the magnet assemblies can accommodate both the circumferential (Axial force producing) coil and the perpendicular (Radial force producing) coils. Hence, in an assembly with two such units, one at each end of an extended shaft, a fully suspended and controlled body is obtained. It is totally non-contacting, virtually friction-free and if desired rotateable. See FIG. 4

Some applications do not allow or lend themselves to a thru shaft of extended length. It will be shown that additional segmented (in quadrents) coils can also be added to the structure and previously described coil arrangements, such that angular displacements about the X and Y axes can be controlled and restrained. Thus a five degree of freedom system of this type is obtainable in a single unified assembly. This has great utility by permitting easy disassembly and reassembly with no damage and allowing certain applications needing accessibility to be accomplished.

Rotational control and torque production is a well developed technology and the non-contacting means for this electrical to mechanical energy transformation can be implemented by brushless (electronically commutated) d.c. motors.

To take full advantage of the minimally disturbing forces of this invention the motor technology employed should be of the “ironless armature” type which also has the virtue of fast response and greatest linearity of control.

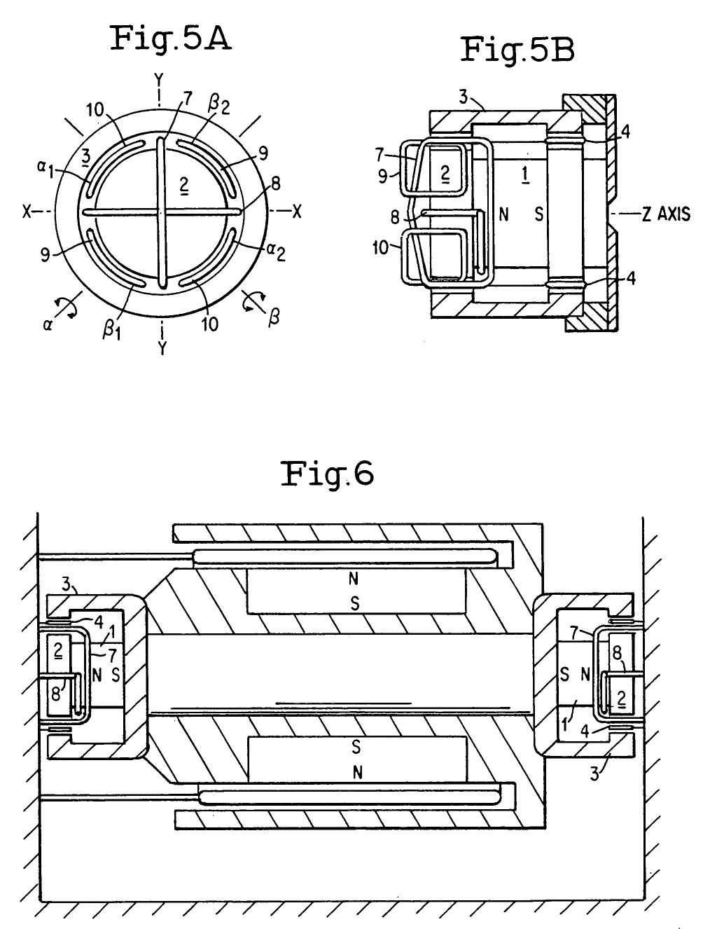

FIG. 5 shows an “ironless armature” brushless d. c. motor integrated with the bearing of this herein disclosed type to provide a total six degree of freedom suspension and fully controllable system.

Rotational control and torque production is a well developed technology and the non-contacting means for this electrical to mechanical energy transformation can be implemented by brushless (electronically commutated) d. c. motors.

Some applications do not allow or lend themselves to a thru shaft of extended length. It will be shown that additional segmented (quadrant) coils can also be added to the magnet structure and previously described coil arrangements, such that angular displacements about the X and Y axes can be controlled and restrained. These coil segments are position in such a way that a major portion of each conductor is in a region of high flux density and in which currents flowing produce an axial force at a distance from the central axis, these same currents flow thru a similar coil 180 degrees displaced and are connected to each other so that the current direction in each high flux region is always oppositely directed and so produces oppositely directed forces and resultant torques as described. Thus a five degree of freedom system of this type is obtainable in a single unified assembly. This has great utility by permitting easy disassembly and reassembly with no damage and allowing certain applications to be accomplished. For example, if one wished to produce a platform for a disk drive unto which a disc could be readily laid upon and spun up with ease and precise positioning and control, it could be readily accomplished as illustrated in FIG. 6.

It will be recognized that all of these machines can be implemented with other functionally similar devices, for example the motor drive might be conventional (brush type) d.c. motors, a. c. motors, or used in a generator mode such as wind turbines which need to minimize starting torque, rotational losses, and require minimal environmental susceptibility and maintenance. The bearing functions themselves can be employed separately or in various combinations with other magnetic or mechanical techniques. For example, if this bearing technique were to perform radial control over a system with a conventional d. c. motor, its minimum reluctance position might provide adequate axial positioning. Therefore various combinations and geometries can be employed without departing from the spirit and intent of this disclosure.

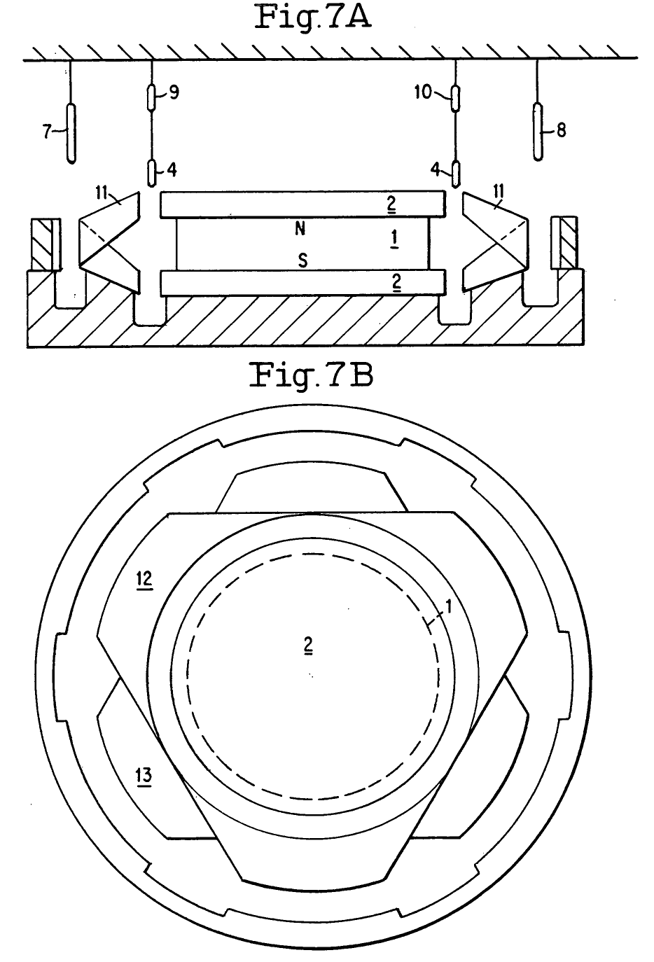

A preferred embodiment is shown next—FIG. 7 This shows a single disc magnet (either permanent or an electromagnet) with a slightly larger diameter permeable disk on each face. These are surrounded by a two-piece continuous to salient poles permeable ring which afford a number of alternately polarized (ie. N and S magnetic poles) around its outer periphery. These interlocking rings are held fixed to one another but separated by any non-magnetic material and spaced outboard but concentric with the aforementioned permeable disks. This spacing provides a high flux density slot between these magnetic elements into which a continuous coil of conductors (to provide axial forces) and segmented coils controlled to provide “tilt” or cross-axis torques) between the moveable magnetic assembly and electrically powered stator elements. Coils with axially directed conductors, yielding lateral forces as described earlier in this disclosure may also share these slots giving radial forces.

The alternating polarity salient poles are themselves surrounded by a permeable ring which affords a return path for the magnetic flux around its circumference to the oppositely polarized surface. The ring itself may be equipped with saliencies or even additional permanent magnets. This ring assembly is a larger diameter and held fixed and concentric with respect to the first mentioned salient poles such that they move and rotate together. Into this outer slot are the motor coils themselves, all normally connected and commutated to produce controllable torques or to generate relatively constant current. Some fraction of these conductors may as readily be connected to produce radial forces for bearing purposes. In order to do this, conductors 180 degrees apart are energized to produce forces in the same direction thus they sum to produce lateral force rather than a torque couple. At 90 degrees (perpendicular to this pair) two similar groups of conductors are likewise connected and controlled (each pair with respect to displacement sensors on its axis) thereby providing radial force capability over the entire plane. These forces may replace or supplement those produced by other means.

This embodiment illustrates how this bearing technique can supply bearing functions in all five degrees of freedom and, in conjunction with known motor techniques, a six degree of freedom system powered and controlled with no physical contact.

List of Numbers Used on FIGS. 1 thru 7 Alternative Magnetic Bearing

1. Magnet
2. Ferrous flux path
3. Ferrous flux path
4. Multi-turn coil
5. Shaft
6. Bushing
7. Radial control coil
8. Radial control coil
9. “Tilt” control coil pair
10. “Tilt” control coil pair
11. Continuous to salient pole ferrous flux paths
12. Salient pole flux path of N (North) magnetic poles
13. Salient pole flux path of S (South) magnetic poles

### Titles of Illustrations

FIG. 1. Magnetic thrust bearing

FIG. 2. Mechanically supported, rotatable magnetic thrust bearing

FIG. 3. Radial Magnetic Bearing

FIG. 4. Dual Radial Magnetic Assembly

FIG. 5. Unified 5 D.O.F. Magnetic Bearing Module

FIG. 6. Motorized 5 D.O.F. Magnetic Bearing Assembly

FIG. 7. Preferred Embodiment, Motorized 6 D.O.F. Magnetic Bearing Assembly—Separable and Accessible Modular Assembly

FIG. 1.

1. Source of magnetic flux, may be either a permanent magnet as shown or an electromagnet.

2. High permeability “ferrous” material

3. Cup shaped high permeability material.

1,2, & 3. Mechanically fastened together, they focus magnetic flux across the circumferential slot between 2 and 3. In this slot is a multi-turn coil of conductors (4) which, when energized, is capable of producing axial forces on the magnet structure.

FIG. 2.

1,2,3,4,5,6. This figure shows the same fixed coil (4) centered in slot of an identical magnet assembly shown mechanically held concentric by means of the bushing (6) restraining shaft (5) but free to move axially as it can do when current is made to flow in the coil.

FIG. 3.

1,2,3,7,8. This figure shows a similar magnet assembly in whose circumferential slot are coils (7) and (8); each of which when energized can produce lateral forces on the magnet assembly, perpendicular to the axial length of conductor in the airgap and to the radialy directed magnetic flux in the airgap. This is similar to motor action except that here both output force vectors are directed in the same direction where they add, producing a lateral force rather than a torque.

The two coils (7) and (8), when the current in each is controlled proportionally with respect to position sensors on its respective axis cover the whole 360 degree plane of the current and flux interaction output.

FIG. 4.

1,2,3,7,8. This figure shows two such coils and physically connected magnet assemblies, both ends of which can be controlled as aforementioned the result being that the magnet assembly structure is controlled in 4 degrees of freedom yet is free to rotate without contact.

FIG. 5.

1,2,3,4,9,10. Shows another means of controlling the cross axis (tilt) motion cited above in FIG. 4. In this case, coil pairs (9) and pairs (10) are shown sharing the same slot with coils 7 and 8. These coil pairs occupy arcuate segments and are connected such that current always flows in the opposite direction with respect to its mate, 180 degrees away. Thus the axial forces produced by each element are oppositely directed, resulting in a torque about their plane of action.

As stated, this is another way to achieve 4 degree of freedom control and it does not require a shaft of extended length.

FIG. 6.

1,2,3,7,8. FIG. 6 shows the bearing arrangement of FIG. 4 used to suspend a well-known type of d.c. motor (informally refered to as “ironless armature” and “basket armature”). The key feature is that there is no magnetic attraction between between the rotor and stator, therefore it does not compromise the advantages of these magnetic bearings. Now a five degree of freedom system is shown and axial control can readily be added as shown in FIG. 5.

FIG. 7.

1,2,3,4,9,10,11,12. The “preferred embodiment” shown in FIG. 7 includes an airgap at each end of the magnetic flux source, allowing separate space for the trust (4) and “tilt” (9 and 10) control coils.

A second (outer) circular slot permits room for motor coils in the conventional manner and interspersed at 90 degree locations space for radial control coils as shown previously (FIG. 3).

The intermediary member (11) is composed of two high permeability members which lead flux from the facing circular surfaces, with no discontinuities to two or more (3 shown) salient poles for more effective motor action. They are fixed to each other but magnetically separated by any non-magnetic material. This type of motor construction has been found to be very effective and efficient by the writer.

1. I claim a magnetic bearing having at least one source of magnetic flux caused to flow across a gap, or gaps, in its structure in which current carrying conductors interact with said flux to control the movement of the magnetic structure and its attachments without physical contact or electrical connection to the moveable structure.

2. I also claim the bearing of claim one in which the gap in the magnetic structure is circularly symmetric allowing free rotational motion of the suspended structure with no other relative motion between the suspended magnetic structure and the fixed control coils.

3. I also claim the bearing of claim one where the force between the current carrying conductors and the magnetic flux is linearly related to the magnitude and direction of the electric currents which are controlled and modulated with respect to a position sensor or sensors.

4. I claim a magnetic suspension system employing forces produced by the interaction of controlled electric currents and a relatively constant magnetic flux to restrain and/or control a body which may also contain motor means to induce or control rotation, or other desired movements without physical or electrical contact between the suspended body and the fixed elements.

5. I claim the bearing system of claim 4 in which the desired motion is linear and in which motor actions are employed to reduce or control rotational and/or lateral motions around or perpendicular to this desired direction of motion.

6. I also claim a bearing of claim 4 in which the desired motion is rotational and the bearings offer little or no “starting” torque and minimal rotational losses to achieve high efficiency and greater effectiveness.

7. I also claim a bearing system of claim 4 in which one or more degrees of freedom are controlled by other means, magnetic or mechanical.

8. I claim the invention of a magnetic bearing in which the current carrying conductors are so arranged to produce desired motion in five or more degrees of freedom in a single modular assembly.

9. I claim the bearing of claim 8 in which the magnetic structure can be withdrawn or removed without harm or damage to any constituent parts.

10. I also claim the bearing of claim 8 in which no extended shaft is required and upon which a platform or other surface may be used to mount devices for controlled rotation and /or other precise positioning and control.

11. I also claim a bearing of claim 1 or 8 in which the forces are electronically controlled by sensors responsive to position and/or rates of movement over which control is desired.

12. I also claim a bearing of claim 1 or 8 in which the forces are controlled by analog or digital techniques including servo means to hasten or stabilize the response to said forces.

13. I also claim a bearing system of claim 4 in which the motor means relies on “ironless armature” construction to reduce unwanted forces between the armature and stator, either linear or rotary.

14. I also claim a system of claim 4 which includes sensors of sufficient sensitivity, accuracy, and response rate to permit the degree of control over the position and rate of movement, placed on the stationary element to allow the degree of control desired on each axis.

15. I also claim a bearing system of claim 4 which has accessible terminations for each of the control coils to permit their being used as output loads of analog or digital servo amplifiers.

16. I also claim a suspension system of claims 4, 14, and 15 which has electronic means to provide suitable control currents of sufficient power to produce forces of the desired magnitude and direction in response to error signals from each of the sensors, these controlled outputs having been processed by good servo techniques.

17. I also claim the bearing of claim one in which some of the conductors and magnet structure are utilized to produce lateral (bearing forces) and some of the same structure and other conductors are used to produce torques as normal motor/generator action.
